(19) United States
(12) Patent Application Publication
(10) Pub. No.: US 2004/0240657 A1
(43) Pub. Date: Dec. 2, 2004

(54) Technique for selecting switched connections for distributing calls through an information assistance provider

(76) Inventor: David W. Camarillo, Portland, OR (US)

Correspondence Address: Alex L. Yip, Kaye Scholer LLP, 425 Park Avenue, New York, NY, 10022, US

(21) Appl. No.: 10/447,502

(22) Filed: May 28, 2003

(51) Int. Cl. H04M 7/00

(52) U.S. Cl. 379/221.02; 379/224

(57) ABSTRACT

The invention is directed to selecting access tandem switches to be connected to an information assistance provider. It has been recognized that each access tandem switch serves a telephone user population which varies with the NPA/NXXs associated therewith. In accordance with the invention, the information assistance provider selects for connection, as few access tandem switches serving as many telephone users as possible. To that end, for each access tandem switch, data about how many telephone users are assigned to each NPA/NXX associated with the access tandem switch is analyzed to assess the number of telephone users served by the access tandem switch.

### FIELD OF THE INVENTION

The invention relates to a communications system and method, and more particularly to an information assistance system and method for distributing calls through an information/call center.

### BACKGROUND OF THE INVENTION

It is commonplace that a user calls an information assistance provider for information, e.g., a telephone listing of a desired party, identified by the party's name and location, e.g., city and state. In response, the provider searches a directory database. Once the operator finds the requested listing, the user may choose to be connected to the destination telephone number of the requested listing, without the user's terminating the initial call and dialing the destination telephone number. To that end, the information assistance provider establishes an outgoing connection to the destination number, and connects the user's call to such a connection. The outgoing connection typically is established through one or more access tandem and end office switches in a public switched telephone network (PSTN). The actual access tandem switch and end office switch involved depends on the number plan area (NPA), also known as an “area code”, and the prefix (NXX), i.e., the three digits immediately following the NPA, of the destination telephone number. In prior art, an information assistance provider typically pays a telephone carrier for access to virtually all access tandem switches administered by the telephone carrier in anticipation of user requests for making connections to all possible destination telephone numbers.

### SUMMARY OF THE INVENTION

The invention is premised upon a recognition that each access tandem switch does not serve the same number of telephone users. Rather, each access tandem switch serves a telephone user population which varies with the NPA/NXXs associated therewith. For example, if the NPA/NXXs associated with an access tandem switch correspond mostly to metropolitan areas, such an access tandem switch would most likely serve many more telephone users than another access tandem switch associated with the NPA/NXXs corresponding mostly to rural areas. In short, access tandem switches are not configured to be “equal” and may serve significantly different numbers of telephone users. In accordance with the invention, an information assistance provider selects, at its disposal, as few access tandem switches serving as many telephone users as possible in order to save on the connection charges the information assistance provider pays to a telephone carrier for establishing call connections through access tandem switches administered by the carrier. (Such connection charges are based, in part, on the number of access tandem switches made accessible to the information assistance provider.) For example, those access tandem switches serving more than a predetermined number of telephone users, e.g., 5,000, may be selected.

In accordance with the invention, for each access tandem switch, data about how many telephone users are assigned to each NPA/NXX associated with the access tandem switch is analyzed to assess the number of telephone users served by the access tandem switch. In this illustrative embodiment, the number of telephone users assigned to each NPA/NXX is determined by summing up the different phone numbers having the same NPA/NXX, which are listed in a conventional telephone directory database. In addition, the number of telephone users served by each access tandem switch is determined by adding up the numbers of telephone users assigned to the respective NPA/NXXs associated with the access tandem switch. A decision is then made as to which access tandem switches should be selected to be at the disposal of the information assistance provider.

### BRIEF DESCRIPTION OF THE DRAWINGS

Further objects, features and advantages of the invention will become apparent from the following detailed description taken in conjunction with the accompanying drawing showing an illustrative embodiment of the invention, in which:

FIG. 1 is a block diagram of an information/call center in accordance with the invention;

FIG. 2 illustrates a prior art arrangement in which access tandem switches are connected to end office switches;

FIG. 3 is a table associating access tandem switches with NPA/NXX's;

FIG. 4 illustrates a prior art telephone directory database;

FIG. 5 is a table associating NPA/NXXs with the quantities of telephone numbers having the NPA/NXXs in accordance with the invention;

FIG. 6 is a flow chart depicting a process for selecting access tandem switches for use by the information/call center in accordance with the invention; and

FIG. 7 illustrates a database for identifying the selected access tandem switches.

### DETAILED DESCRIPTION

The invention is directed to selecting access tandem switches for use by an information assistance provider to establish call connections to destination telephone numbers desired by an information assistance caller. The invention is premised upon a recognition that each access tandem switch in a public switched telephone network (PSTN) does not serve the same number of telephone users. Rather, each access tandem switch serves a telephone user population which varies with the NPA/NXXs associated therewith. In short, access tandem switches are not configured to be “equal” and may serve significantly different numbers of telephone users.

An information assistance provider typically pays a telephone carrier connection charges for establishing call connections through access tandem switches administered by the carrier. Since such connection charges, in part, are based on the number of access tandem switches made accessible to the information assistance provider, it is cost-effective for the information assistance provider to limit the number of such access tandem switches. Thus, in accordance with the invention, an information assistance provider selects, at its disposal, as few access tandem switches serving as many telephone users as possible. For example, those access tandem switches serving more than a predetermined number of telephone users, e.g., 5,000, may be selected. With the invention, the information assistance provider advantageously utilizes the few, selected access tandem switches for establishing call connections to a majority (e.g., 90%) of telephone users. In the less likely event that the information assistance provider needs to establish a connection to a telephone user in the minority population, the information assistance provider may pay special charges for such a connection on a per connection basis. Even in that case, the overall connection charges is likely reduced, compared with the prior art case where an information assistance provider indiscriminately subscribes to virtually all access tandem switches serving virtually all telephone users.

In accordance with the invention, for each access tandem switch, data about how many telephone users are assigned to each NPA/NXX associated with the access tandem switch is analyzed to assess the number of telephone users served by the access tandem switch. In this illustrative embodiment, the number of telephone users assigned to each NPA/NXX is determined by tallying the different phone numbers having the same NPA/NXX, which are listed in a conventional telephone directory database. In addition, the number of telephone users served by each access tandem switch is determined by adding up the numbers of telephone users assigned to the respective NPA/NXXs associated with the access tandem switch. A decision is then made as to which access tandem switches should be selected to be at the disposal of the information assistance provider.

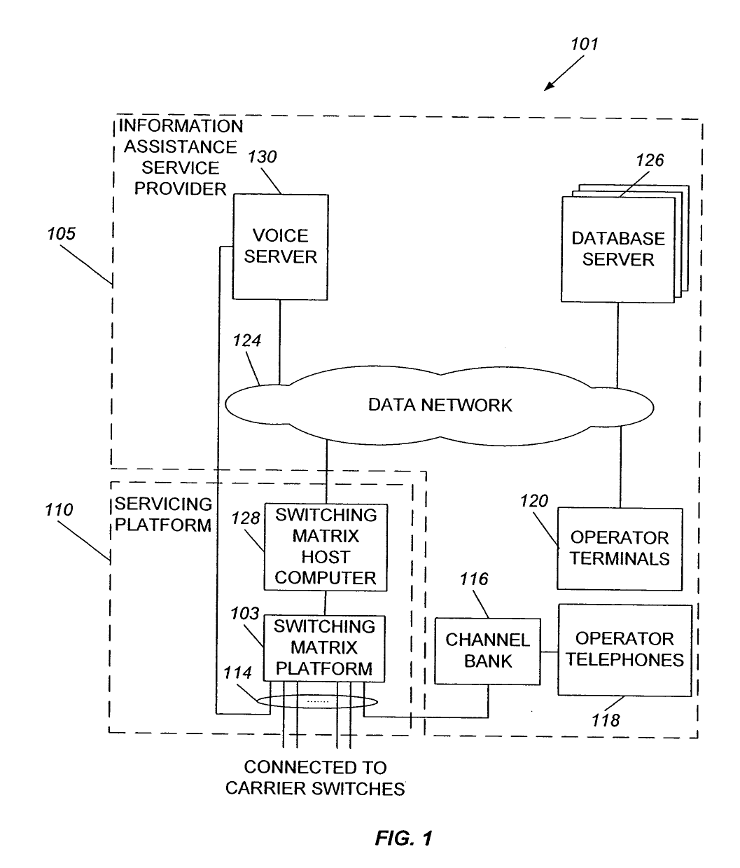

FIG. 1 illustrates information/call center 101 attended by operators, which includes information assistance service provider 105 and servicing platform 110. It should be noted that even though both provider 105 and servicing platform 110 appear in the same figure, they may or may not be located in the same geographic area. Servicing platform 110 comprises switching matrix host computer 128, and switching matrix platform 103 which is connected via T1 communication links 114 to, among others, voice server 130 and channel bank 116 in provider 105. T1 communication links 114 provide connection between the information/call center's switching matrix platform 103 and carrier switches through which incoming information assistance calls are received and outgoing calls are placed (which links may be different than that used for incoming calls). In this instance, the carrier switches include selected access tandem switches in accordance with the invention,

Channel bank 116 is used to couple multiple operator telephones 118 to platform 103. The operators in center 100 are further equipped with operator terminals 120, each of which includes a video display unit and a keyboard with associated dialing pad. Operator terminals 120 are connected over data network 124 to one or more database server(s) 126 (although only one is shown here). Database server 126 provides access to, among others, a conventional directory database. Data network 124 further connects to voice server 130, and switching matrix host computer 128, which in turn is connected to switching matrix platform 103 via a data link.

Voice server 130 is used to play the constant repeated parts of an operator's speech, namely, the various greetings and signoffs (or closings). Voice server 130 is connected via data network 124 to host computer 128 and via one or more T1 spans to platform 103. Voice server 130 may comprise a general-purpose computer and one or more voice cards for voice recognition, voice recording and playback, and call progress analysis. At appropriate stages in a call progression, host computer 128 initiates a voice path connection between voice server 130 and platform 103 such that the caller, or the caller and the operator, are able to hear whatever pre-recorded speech is played on that connection by voice server 130. Host computer 128 then instructs voice server 130, via data network 124, what type of message to play, and passes data parameters that enable voice server 130 to locate the message appropriate to the call state.

Users of a particular telephone carrier may dial, speak or otherwise communicate predetermined access digits, access codes or retail numbers, or input a predetermined address or URL (uniform resource locator) established by the carrier to access information/call center 101. For example, the predetermined access digits may be “411,” “*555,” “555-1212,” “00,” etc. An incoming call requesting information assistance is received by switching matrix platform 103, which connects it to an available operator's telephone. If no operator is available when a call is received, the call is queued in a conventional manner until an operator becomes available. In this instance, automatic call distribution (ACD) logic of conventional design (not shown) is used to queue and distribute calls to operators in the order in which they are received, and such that the call traffic is distributed evenly among the operators. The ACD logic may reside in host computer 128 or elsewhere in information/call center 101. In other instances, other distribution logic schemes may be utilized, such as skills-based routing or a priority scheme for preferred users.

Once connected to an operator at information/call center 101, a user may request connection information, e.g., a telephone number, of a desired destination party. In response, an operator may conduct a search on database server 126. When the requested destination telephone number is located, the user is afforded an option to be connected to the destination telephone number, without his/her terminating the information assistance call and dialing the destination telephone number. If such an option is selected, switching matrix platform 103 establishes an outgoing connection to the destination number, and connects the user's call to such a connection. The outgoing connection in this instance is established through one of the selected access tandem switches connected to platform 103.

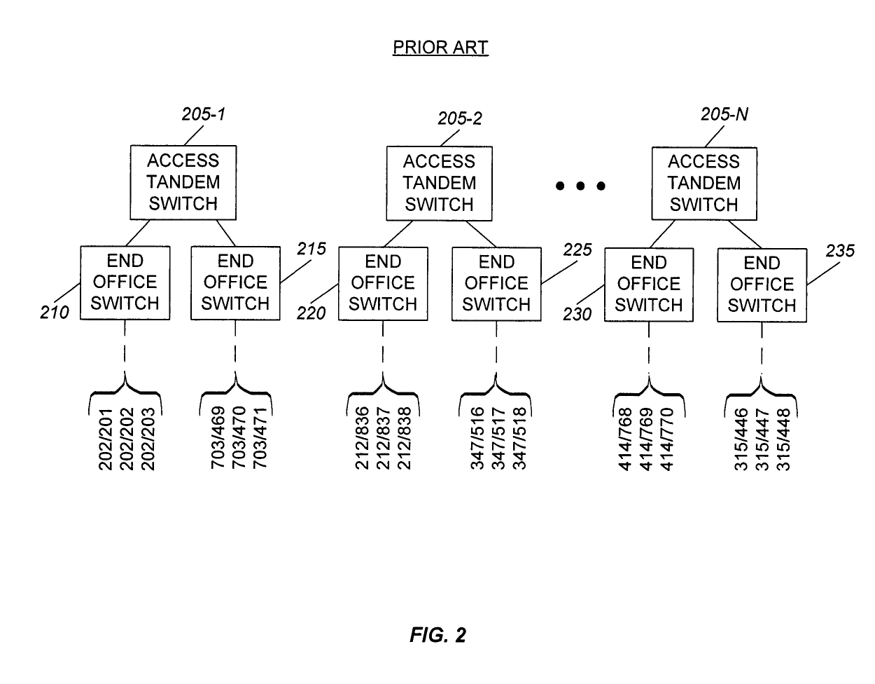

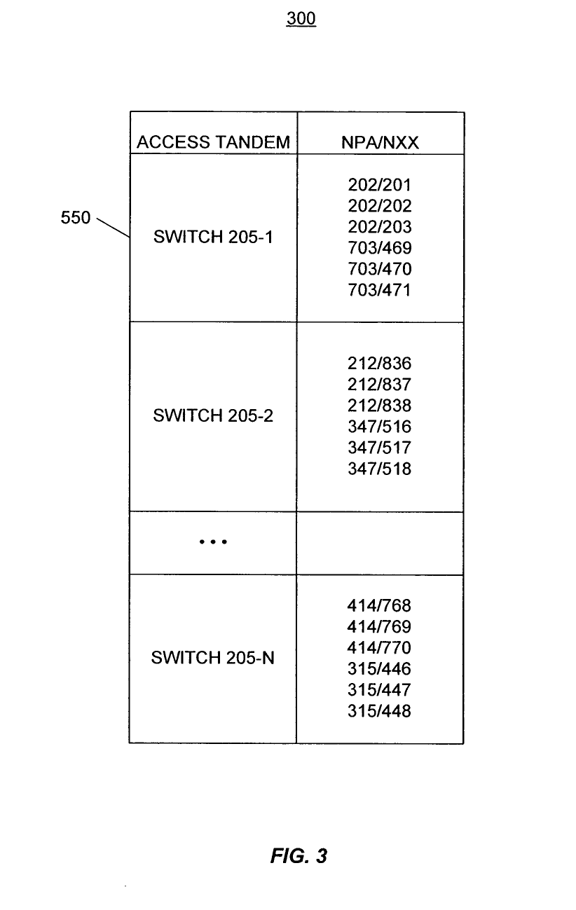

The methodology for selecting access tandem switches for use by an information assistance provider in accordance with the invention will now be described. FIG. 2 illustrates in a prior art PSTN access tandem switch 205-1 connected to end office switches 210 and 215, access tandem switch 205-2 connected to end office switches 220 and 225, . . . and access tandem switch 205-N connected to end office switches 230 and 235, where N represents an integer. As shown in FIG. 2, access tandem switch 205-1, together with end office switch 210, is configured to connect calls to telephone numbers having NPA/NXXs=202/201, 202/202 and 202/203. In addition, access tandem switch 205-1, together with end office switch 215, is configured to connect calls to telephone numbers having NPA/NXXs=703/469, 703/470 and 703/471. As such, access tandem switch 205-1 in this instance serves the telephone users having telephone numbers with 202/201, 202/202, 202/203, 703/469, 703/470 and 703/471 as NPA/NXXs. Similarly, access tandem switch 205-2 (205-N), together with end office switch 220 (230), is configured to connect calls to telephone numbers having NPA/NXXs=212/836 (414/768), 212/837 (414/769) and 212/838 (414/770). In addition, access tandem switch 205-2 (205-N), together with end office switch 225 (235), is configured to connect calls to telephone numbers having NPA/NXXs=347/516 (315/446), 347/517 (315/447) and 347/518 (315/448). As such, access tandem switch 205-2 (205-N) in this instance serves the telephone users having telephone numbers with 212/836 (414/768), 212/837 (414/769), 212/838 (414/770), 347/516 (315/446), 347/517 (315/447) and 347/518 (315/448) as NPA/NXXs. Based on the prior art arrangement of FIG. 2, table 300 in FIG. 3 tabulating access tandem switches 205-1 through 205-N and the associated NPA/NXXs is readily constructed.

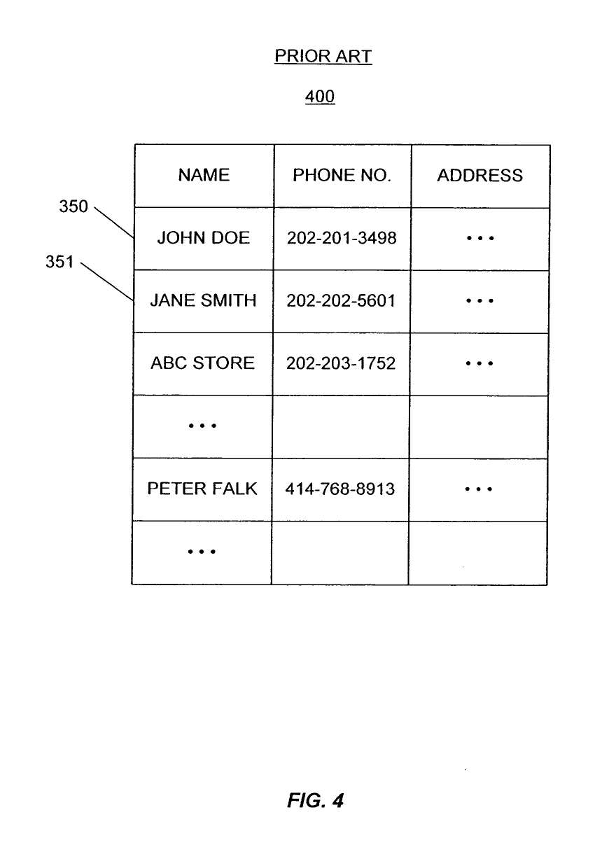

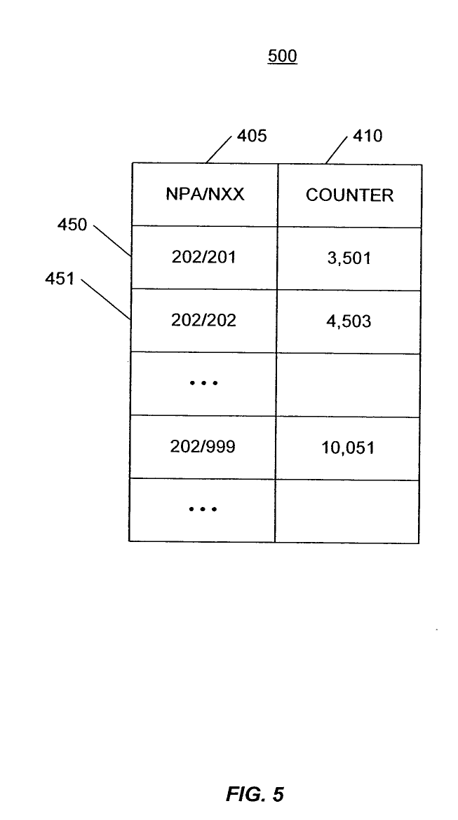

In this illustrative embodiment, database server 126 is programmed to determine the numbers of telephone users served by access tandem switches 205-1 through 205-N, respectively. As mentioned before, database server 126 has access to a conventional directory database. FIG. 4 illustrates one such database, denoted 400 containing listings or directory records 350, 351, etc. In accordance with the invention, server 126 goes through directory database 400 and determines the quantity of different telephone numbers associated with each NPA/NXX, which are listed in the directory database. To that end, server 126 establishes counters for different NPA/NXXs, respectively, which are illustrated in table form in FIG. 5. For example, when database server 126 comes across each of those directory records (e.g., record 350) containing phone numbers having 202/201 as the NPA/NXX, it increments the counter for 202/201 by one (corresponding to row 450 in table 500); when database server 126 comes across each of those records (e.g., record 351) containing phone numbers having 202/202 as the NPA/NXX, it increments the counter for 202/202 by one (corresponding to row 451 in table 500); etc. As a result, after server 126 goes through directory database 400 in its entirety, table 500 contains the total tally of telephone users associated with each NPA/NXX. In this instance, row 450 indicates that the total number of telephone users associated with 202/201 is 3501; row 451 indicates that the total number of telephone users associated with 202/202 is 4503; etc.

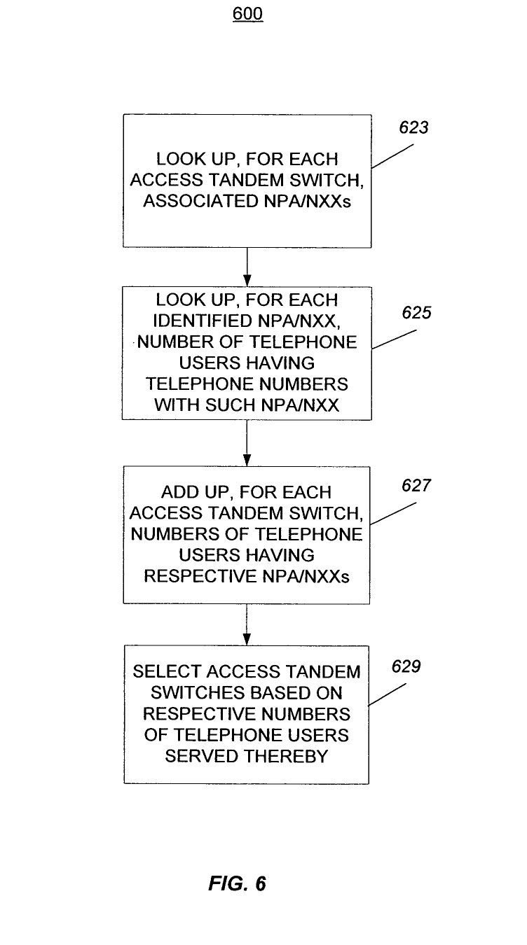

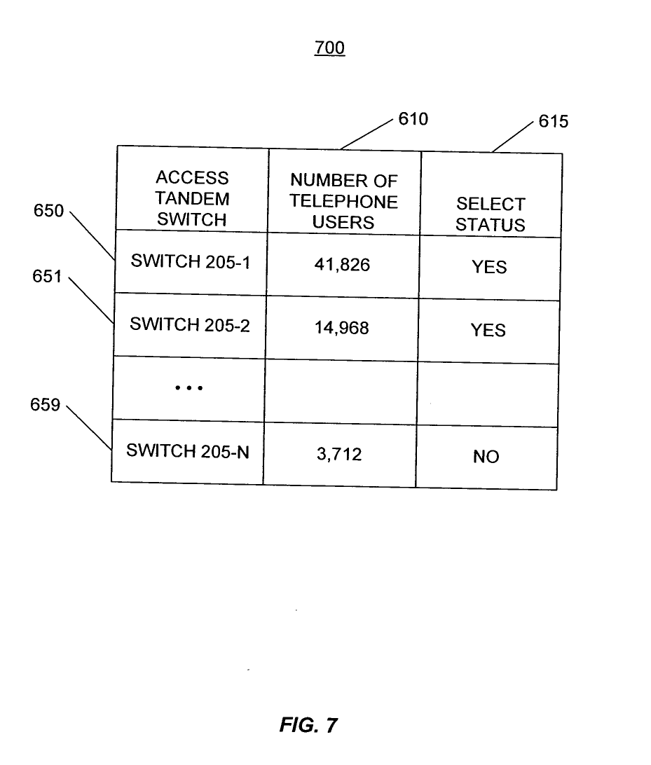

FIG. 6 illustrates a process, denoted 600, performed by database server 126 for selecting access tandem switches for use by information/call center 101 in accordance with the invention. Database server 126 at step 623 looks up in table 300, for each access tandem switch, the associated NPA/NXXs. For example, based on row 550 in table 300, server 126 identifies that NPA/NXXs=202/201, 202/202, 202/203, 703/469, 703/420 and 703/471 are associated with access tandem switch 205-1. To compute the number of telephone users served by access tandem switch 205-1, server 126 at step 625 looks up in table 500, for each identified NPA/NXX, the number of telephone users having telephone numbers with such an NPA/NXX. In this example, server 126 learns that, for 202/201, 3,501 telephone users have telephone numbers with such an NPA/NXX (indicated in row 450); for 202/202, 4503 telephone users (indicated in row 451); for 202/203, 2575 telephone users (not shown); for 703/469, 7683 telephone users (not shown); for 703/470, 12432 telephone users (not shown); and for 703/471, 11132 telephone users (not shown). Database server 126 at step 627 adds up, for each access tandem switch, the numbers of telephone users having the respective NPA/NXXs. Continuing the above example, the resulting sum for access tandem switch 205-1 which reflects the total number of telephone users served thereby is 41826 in this instance. This data is entered in database 700 in FIG. 7, and specifically in field 610 of record 650 concerning switch 205-1.

After entering similar data in field 610 of the remaining records in database 700 concerning access tandem switches 205-2 through 205-N, database server 126 at step 629 selects ones of access tandem switches 205-1 through 205-N based on the respective numbers of telephone users served thereby. In this instance, database server 126 compares the number of telephone users in field 610 of record 650, i.e., 41826, with a predetermined threshold, e.g., 5,000, to determine whether it would be cost-effective for the information assistance provider to employ access tandem switch 205-1. Since in this case the number of telephone users in question exceeds the predetermined threshold, database server 126 selects access tandem switch 205-1 for use (e.g., by indicating “Yes” in field 615 of record 650). Server 126 makes similar comparisons and selections with respect to access tandem switches 205-2 through 205-N. For example, server 126 also selects switch 205-2 but not switch 205-N in this instance.

In another embodiment, the actual access tandem switches selected by server 126 are a function of a ratio of the total number of telephone users served thereby (i.e., the sum of values in field 610 of the records concerning the selected switches in database 700) to the whole telephone user population (i.e., the sum of values in field 610 of all records in database 700). This ratio may be required to exceed a predetermined percentage, e.g., 90%. In that case, the selected access tandem switches allow the information assistance provider to reach 90% of the telephone user population.

It should be noted at this point that the above determination of the number of telephone users served by an access tandem switch is based on the telephone listings published in a conventional telephone directory database. Because (a) some telephone users choose not to publish their telephone listings, (b) some telephone numbers are disconnected but remain listed, and (c) some telephone listings are planted in the directory database to detect copying of its data by others, the above determination accordingly is not completely accurate. However, because the percentage of nonpublished listings, disconnected number listings, and planted listings is normally small, the above determination serves the current purpose of estimating the number of telephone users well (e.g., an order of magnitude is sufficient here). However, it will be appreciated that a person skilled in the art may improve its accuracy, for example, by extrapolating the estimate to factor in nonpublished listings based on the known ratio of the number of nonpublished listings to the number of published listings.

It will also be appreciated that the above-described selection of access tandem switches is updated from time to time, especially when new area codes are introduced, resulting in a change in the number of telephone users associated with new NPA/NXXs and the access tandem switches.

The foregoing merely illustrates the principles of the invention. It will thus be appreciated that those skills in the art will be able to devise numerous other arrangements which embody the principles of the invention and are thus within its spirit and scope.

For example, information/call center 101 is disclosed herein in a form in which various functions are performed by discrete functional blocks. However, any one or more of these functions could equally well be embodied in an arrangement in which the functions of any one or more of those blocks or indeed, all of the functions thereof, are realized, for example, by one or more appropriately programmed processors.

What is claimed is:

1. A method for use by an information assistance provider connecting information assistance callers to desired telephone numbers through selected switches provided by a carrier, comprising:
determining, based on telephone listings, numbers of telephone users served by a plurality of switches provided by the carrier, respectively; and
selecting one or more of the plurality of switches for connecting information assistance callers to desired telephone numbers based on the respective numbers of telephone users served thereby.

2. The method of claim 1 wherein the plurality of switches includes end office switches.

3. The method of claim 1 wherein the plurality of switches includes access tandem switches.

4. The method of claim 1 wherein the plurality of switches includes NPA/NXX switches.

5. The method of claim 1 wherein the respective numbers of telephone users served by the one or more of the plurality of switches is determined as a function of a number of the telephone listings associated with the one or more of the plurality of switches.

6. The method of claim 5 wherein the function includes a sum or a ratio.

7. The method of claim 1 wherein the one or more of the plurality of switches is selected when the respective numbers of telephone users served by the one or more of the plurality of switches is greater than a predetermined number.

8. A method for use by an information assistance provider connecting information assistance callers to desired telephone numbers through selected switches provided by a carrier, comprising:
selecting one or more of the plurality of switches for connecting information assistance callers to desired telephone numbers based on numbers of telephone calls connected to the one or more of the plurality of switches.

9. The method of claim 8 wherein the number of telephone calls connected to the one or more of the plurality of switches includes a function of a number of users served thereby.

10. A system for use by an information assistance provider connecting information assistance callers to desired telephone numbers through selected switches provided by a carrier, comprising:
a processor for determining, based on telephone listings, numbers of telephone users served by a plurality of switches provided by the carrier, respectively, one or more of the plurality of switches for connecting information assistance callers to desired telephone numbers being selected based on the respective numbers of telephone users served thereby.

11. The system of claim 10 wherein the plurality of switches includes end office switches.

12. The system of claim 10 wherein the plurality of switches includes access tandem switches.

13. The system of claim 10 wherein the plurality of switches includes NPA/NXX switches.

14. The system of claim 10 wherein the respective numbers of telephone users served by the one or more of the plurality of switches is determined as a function of a number of the telephone listings associated with the one or more of the plurality of switches.

15. The system of claim 14 wherein the function includes a sum or a ratio.

16. The system of claim 10 wherein the one or more of the plurality of switches is selected when the respective numbers of telephone users served by the one or more of the plurality of switches is greater than a predetermined number.

17. A system for use by an information assistance provider connecting information assistance callers to desired telephone numbers through selected switches provided by a carrier, comprising:
a processor for selecting one or more of the plurality of switches for connecting information assistance callers to desired telephone numbers based on numbers of telephone calls connected to the one or more of the plurality of switches.

18. The system of claim 17 wherein the number of telephone calls connected to the one or more of the plurality of switches includes a function of a number of users served thereby.
